(19) United States
(12) Patent Application Publication
(10) Pub. No.: US 2026/0343434 A1
(43) Pub. Date: Oct. 29, 2026

(54) DYNAMIC POWER BOOST AND DE-BOOST FOR MITIGATION OF INTERFERENCE AT THE CELL EDGE

(71) Applicant: T-MOBILE INNOVATIONS LLC, Overland Park, KS (US)

(72) Inventors: Hirensinh Rupendrasinh Rana, Olathe, KS (US); Krunal Mansukhlal Modasiya, Aldie, VA (US)

(21) Appl. No.: 19/187,819

(22) Filed: Apr. 23, 2025

(51) Int. Cl. H04W 52/36; H04L 41/16; H04W 52/24

(52) U.S. Cl. CPC H04W 52/367; H04L 41/16; H04W 52/245

(57) ABSTRACT

Systems and methods are disclosed for power management at cell edges in wireless communication networks to mitigate interference and optimize signal quality. In accordance with some embodiments, a method includes receiving, by a first base station, one or more signal strength reports from a user device located in a cell edge area. The one or more reports include a signal measurement from at least two base stations. The method further includes determining, based at least on the one or more reports, that the first base station has a stronger signal strength than a second base station for the cell edge area. The method further includes, in response to determining that the first base station has the stronger signal strength, increasing the transmission power from the first base station by a boost value and sending an instruction to the second base station to reduce its transmission power by a de-boost value.

### TECHNICAL FIELD

Various embodiments of the present technology relate to wireless communication networks and, more particularly, to radio access network optimization techniques for signal quality management in cellular network coverage areas with overlapping signals.

### BACKGROUND

Wireless communication networks use multiple base stations, such as gNodeBs (gNBs) in 5G networks, to provide continuous coverage across geographic areas. Each base station creates a coverage area, or cell, within which user equipment (UE) can establish connections to access network services. As networks expand to accommodate growing data demands, network operators deploy additional base stations to increase capacity and coverage, creating a dense network infrastructure. In densely deployed networks, cells often overlap at their boundaries, creating areas known as cell edges. These cell edge areas present unique challenges for network performance and user experience.

At cell edges, UEs receive signals from multiple neighboring base stations simultaneously, which introduces interference issues that can degrade service quality. Signal-to-interference-plus-noise ratio (SINR) is a metric that measures the quality of a received signal relative to interference and background noise. In ideal conditions, UEs connect to the base station providing the strongest signal. However, at cell edges, even when connected to the strongest serving cell, UEs experience reduced SINR due to interference from neighboring cells transmitting on the same frequency bands.

Existing network optimization techniques involve static configuration of transmission parameters, including power levels, based on initial network planning and periodic drive tests. Radio access networks (RANs) collect performance metrics and signal quality reports from UEs to monitor network conditions. The X2 interface in cellular networks enables communication between neighboring base stations, supporting various functions including handover preparation, load management, and general information exchange. Through this interface, base stations can share real-time data about their operational status, resource utilization, and connected UEs, facilitating coordinated network management.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to wireless communication networks and coverage optimization. More specifically, the technology disclosed herein includes systems and methods for dynamically managing transmission power levels between neighboring base stations to mitigate interference and create dominant sector coverage at cell edges.

In a first embodiment, a method includes receiving, by a first base station, one or more signal strength reports from a user device located in a cell edge area. The one or more signal strength reports include at least a signal measurement from the first base station and a signal measurement from a second base station. The method further includes determining, based at least on the one or more signal strength reports, that the first base station has a stronger signal strength than the second base station for the cell edge area. The method further includes, in response to determining that the first base station has the stronger signal strength, sending an instruction to the second base station to reduce a transmission power from the second base station by a de-boost value. The method further includes increasing a transmission power from the first base station by a boost value.

In some examples, determining that the first base station has the stronger signal strength is performed by an artificial intelligence (AI) algorithm deployed on the first base station. The AI algorithm analyzes the one or more signal strength reports to determine the de-boost value and the boost value. In some examples, the method further includes, in addition to receiving the one or more signal strength reports from the user device, receiving other signal strength reports from other user devices located in the cell edge area and determining that the first base station has the stronger signal strength for a majority of the other user devices and the user device before sending the instruction to reduce the transmission power from the second base station.

In some implementations, the one or more signal strength reports further include at least a signal measurement from a third base station, and the method further includes sending a second instruction to the third base station to reduce a transmission power from the third base station by a second de-boost value. In some examples, sending the instruction to the second base station includes communicating with the second base station via an X2 interface. The transmission power from the first base station and the transmission power from the second base station may include synchronization signal block (SSB) power. In some implementations, the de-boost value and the boost value are equal. Determining that the first base station has the stronger signal strength may include comparing a first reference signal received power (RSRP) value associated with the first base station to a second RSRP value associated with the second base station.

In a second embodiment, a system includes one or more computer-readable storage media, a processing system operatively coupled with the one or more computer-readable storage media, and program instructions stored on the one or more computer-readable storage media. The program instructions, when read and executed by the processing system, direct the processing system to at least receive, by a first base station, one or more signal strength reports from a user device located in a cell edge area, where the one or more signal strength reports include at least a signal measurement from the first base station and a signal measurement from a second base station. The program instructions further direct the processing system to determine, based at least on the one or more signal strength reports, that the first base station has a stronger signal strength than the second base station for the cell edge area. The program instructions further direct the processing system to, in response to determining that the first base station has the stronger signal strength, send an instruction to the second base station to reduce a transmission power from the second base station by a de-boost value. The program instructions further direct the processing system to increase a transmission power from the first base station by a boost value.

In yet another embodiment, one or more non-transitory computer-readable storage media have program instructions stored thereon that, when executed by a computing system, direct the computing system to perform operations. The operations include receiving, by a first base station, one or more signal strength reports from a user device located in a cell edge area, where the one or more signal strength reports include at least a signal measurement from the first base station and a signal measurement from a second base station. The operations further include determining, based at least on the one or more signal strength reports, that the first base station has a stronger signal strength than the second base station for the cell edge area. The operations further include, in response to determining that the first base station has the stronger signal strength, sending an instruction to the second base station to reduce a transmission power from the second base station by a de-boost value. The operations further include increasing a transmission power from the first base station by a boost value.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a wireless communications environment in accordance with some embodiments of the present technology;

FIG. 2 is a flowchart illustrating a series of steps performed by a wireless communications network in accordance with some embodiments of the present technology;

FIGS. 3A-3B illustrate an example of power adjustment in a cell edge area in accordance with some embodiments of the present technology;

FIG. 4 is a sequence diagram illustrating a series of steps performed in a wireless communications environment in accordance with some embodiments of the present technology;

FIG. 5 illustrates an example of a wireless communications network in accordance with some embodiments of the present technology;

FIG. 6 illustrates an example of a base station in accordance with some embodiments of the present technology; and

FIG. 7 illustrates an example of user equipment in accordance with some embodiments of the present technology.

### DETAILED DESCRIPTION

The present technology includes systems and methods for dynamically managing power allocation at cell edges in wireless communication networks to optimize signal quality and reduce interference. By leveraging real-time user equipment (UE) signal strength reports and artificial intelligence (AI) algorithms, the system provides network-controlled boosting and de-boosting of synchronization signal block (SSB) power to create dominant sector coverage at cell edge areas and minimize interference from neighboring cells.

In conventional wireless communications networks, cell edge areas frequently experience higher interference due to overlapping signals from multiple base stations (e.g., gNodeBs, eNodeBs, or the like). This interference problem is particularly prevalent in suburban areas where multiple cell sites are deployed to provide both coverage and sufficient bandwidth to support numerous users. When UEs are positioned at cell edges, they may receive signals from multiple sectors with comparable signal strengths, resulting in significant interference. Even when the UE’s connected cell provides adequate signal strength, the interference from neighboring cells degrades the signal-to-interference-plus-noise ratio (SINR), which in turn negatively impacts the modulation scheme assigned to the UE. Inferior modulation schemes lead to reduced data throughput, degraded quality of service, and potential call drops, all contributing to poor customer experience.

Current approaches to mitigating cell edge interference are largely manual and reactive. Network operators review affected cells individually, manually adjust signal strength parameters in the Operations Support System (OSS), and incrementally increase or decrease signal powers. This process is time-consuming, resource-intensive, and lacks the ability to quickly adapt to changing network conditions in real time. Furthermore, without coordinated adjustments between neighboring cells, unilateral power modifications may solve interference issues for some UEs while creating new problems for others, leading to a suboptimal overall network performance.

Thus, the technology disclosed herein addresses these limitations by via a dynamic power management system in which base stations communicate with one another to coordinate power adjustments based on UE-reported metrics. When a UE at a cell edge area submits signal strength reports (e.g., Reference Signal Received Power (RSRP) measurements) to multiple base stations, the base station with the strongest signal automatically assumes the role of a master cell. This master cell executes an AI algorithm to analyze the signal reports and determine appropriate power adjustments. The master cell then increases its own transmission power by a calculated boost value, while simultaneously instructing secondary cells to reduce their transmission power by a de-boost value using the X2 interface for inter-base station communication. This coordinated approach creates a dominant coverage from one sector at the cell edge, effectively reducing interference while maintaining or improving overall signal quality for UEs in the area.

The power adjustment process operates dynamically and automatically, without requiring manual intervention from network operators. The base stations collect quality reports from UEs in the cell edge area to ensure that power adjustments benefit the majority of affected devices. By analyzing reports from numerous UEs, the system makes statistically sound determinations regarding which base station should serve as the master cell. This approach prevents oscillations in power adjustments that might occur if decisions were based on reports from a single UE. When a base station is designated as the master cell, it calculates appropriate boost and de-boost values using the AI algorithm, which considers factors such as current signal strengths, interference levels, and potential impacts on users throughout the coverage area. In some implementations, these values may be equal in magnitude (e.g., a 3 decibel (dB) boost matched with a 3 dB de-boost) to maintain overall network energy efficiency while creating the signal differential at the cell edge.

Various technical effects may be appreciated from the implementations disclosed herein. Such technical effects include improved signal-to-interference-plus-noise ratio (SINR) at cell edge areas, optimized spectrum utilization, and enhanced network resource allocation efficiency. By dynamically adjusting the power levels between neighboring base stations, the system reduces inter-cell interference without requiring additional spectrum or hardware deployments. The coordinated power adjustment mechanism creates a more favorable radio environment with clearly defined dominant sectors, allowing for higher-order modulation schemes to be utilized in previously interference-limited areas. This results in increased spectral efficiency, as the same frequency resources can now support higher data rates.

Additionally, the AI-driven approach to power management reduces network signaling overhead by eliminating the need for continuous manual reconfiguration of multiple network elements. The X2 interface communication between base stations enables real-time coordination without burdening the core network with excessive control signaling. Furthermore, the distributed nature of the decision-making process, where determinations are made at the base station level rather than at a centralized controller location, reduces latency in power adjustment responses and improves the system’s ability to adapt to rapidly changing radio frequency environments.

In complex network deployments with multiple overlapping cells, the granular power control mechanism may provide even greater benefits. By individually adjusting the power levels of each contributing base station based on its specific interference impact, the system creates an optimized radio environment that maximizes overall spectral efficiency. This targeted approach prevents scenarios where multiple interfering signals at similar power levels create persistent interference patterns despite power adjustments to a single secondary base station. The AI-driven algorithm’s ability to calculate appropriate boost and de-boost values for numerous overlapping cells simultaneously represents a significant advancement over traditional interference mitigation techniques.

While the technology described herein is primarily discussed in the context of Fifth Generation (5G) and Fourth Generation (4G) Long-Term Evolution (LTE) cellular networks and infrastructure, the underlying principles and methodologies for dynamic power management at cell edges can be broadly applied to other generations of wireless communication technologies and protocols facing similar interference challenges. The disclosed solution, which dynamically adjusts transmission power levels between neighboring cells based on signal quality reports, can extend to future wireless standards, including 6G and beyond, where cell edge interference management will remain a critical performance factor. Similarly, in multi-RAT (Radio Access Technology) environments, where heterogeneous network elements must coordinate to provide seamless coverage, a comparable dynamic power adjustment mechanism may be employed. The core concept of creating dominant sector coverage through coordinated power boosting and de-boosting can be adapted to various wireless technologies wherever signal quality degradation occurs due to competing transmissions from multiple sources.

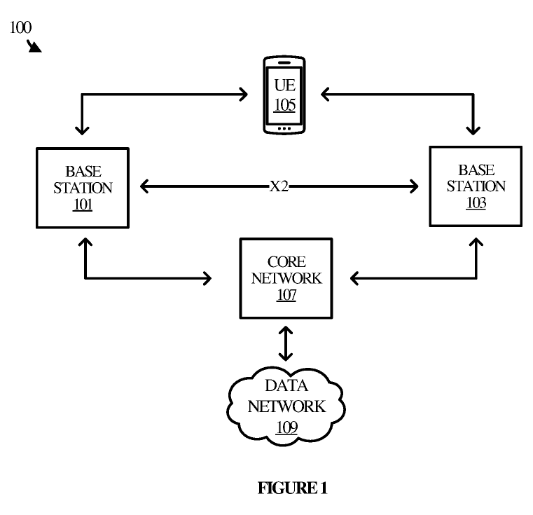

FIG. 1 illustrates wireless communications environment 100. Wireless communications environment 100 includes base station 101, base station 103, user equipment (UE) 105, core network 107, and data network 109. The elements depicted in FIG. 1 are presented solely for purposes of example, and wireless communications environment 100 may include additional, fewer, or alternative elements than those illustrated in the example of FIG. 1.

In accordance with the present example, base station 101 and base station 103 are representative of network infrastructure elements that facilitate wireless communication between UE 105 and the broader network. Base station 101 and base station 103 may be eNodeBs (eNBs), gNodeBs (gNBs), or other radio access network (RAN) nodes capable of managing uplink and downlink transmission. Each base station may include radio transceiver circuitry, multiple antennas, a baseband processor, digital signal processing (DSP) components, memory, and one or more processors that execute network control operations. Base station 101 and base station 103 are configured to communicate with each other via an X2 interface, which enables direct coordination for power management functions without requiring intervention from core network 107. Base station 101 and base station 103 are further equipped with radio resource management (RRM) modules, artificial intelligence (AI) algorithms for signal analysis, and control components to dynamically adjust transmission power levels based on UE signal strength reports.

Base station 101 and base station 103 may be implemented as part of a terrestrial network, non-terrestrial network, or hybrid network in which multiple access technologies are integrated to provide greater connectivity and coverage. As terrestrial deployments, base station 101 and base station 103 may be configured as traditional ground-based gNBs, eNBs, or the like. However, in alternative implementations, base station 101 and/or base station 103 may be deployed as part of non-terrestrial network (NTN) architectures, including airborne platforms such as high-altitude platform stations (HAPS) and unmanned aerial vehicles (UAVs), or space-based communication systems such as low Earth orbit (LEO), medium Earth orbit (MEO), or geostationary orbit (GEO) satellites. In hybrid configurations, one base station may be terrestrial while the other is non-terrestrial, with the dynamic power management techniques described herein being equally applicable to mitigate interference at the boundaries between terrestrial and non-terrestrial coverage areas. The X2 interface communication between base stations can be adapted to facilitate coordination across these varied deployment scenarios, allowing the power boost and de-boost methodology to optimize signal quality regardless of whether the overlapping signals originate from ground-based or space-based transmission sources.

The AI algorithm deployed on base station 101 and base station 103 is a specialized computational model designed to analyze signal strength reports and make intelligent power adjustment decisions for cell edge interference mitigation. Each base station may implement its own instance of the algorithm, allowing for distributed decision-making across the network. The algorithm may be implemented using various machine learning approaches, including but not limited to supervised learning models, reinforcement learning systems, neural networks, random forests, support vector machines, or Bayesian networks. These algorithms are trained to recognize patterns in signal strength data and identify optimal power adjustment strategies based on historical performance outcomes. The AI processing may occur within dedicated AI accelerator chips integrated into the base station hardware, or within the base station’s central processing unit (CPU), digital signal processor (DSP), or field-programmable gate array (FPGA) components. When operational, the algorithm ingests the RSRP measurements from UEs, evaluates the relative signal strengths from competing base stations, considers secondary factors such as timing advance (indicating UE distance from the cell), current network load, historical performance data, and the like, and then calculates appropriate boost and de-boost values. The algorithm may employ a decision threshold to prevent unnecessary power adjustments for marginal signal differences. The algorithm may also incorporate predictive elements to anticipate UE movement and proactively adjust power levels. Moreover, the algorithm is configured to balance the needs of individual UEs with broader network optimization goals, ensuring that power adjustments benefiting one UE do not adversely affect other users in the coverage area.

UE 105 is representative of a wireless user device located in a cell edge area between the coverage zones of base station 101 and base station 103. Exemplary user devices include phones, smartphones, tablets, laptops, and other wireless communication devices capable of connecting to cellular networks. UE 105 may include radio transceiver circuitry (XCVR), antennas, digital signal processing (DSP) components, amplifiers, filters, memory, as well as a central processing unit (CPU) and associated user circuitry for device operation. UE 105 is configured to measure signal strengths from multiple base stations and periodically report these measurements to the network. These reports may include Reference Signal Received Power (RSRP) values, which provide an indication of the signal strength in dBm that UE 105 is receiving from each base station. UE 105 wirelessly communicates with data network 109 via base station 101, base station 103, or another base station and core network 107.

Core network 107 represents a central network infrastructure responsible for managing control signaling, mobility, authentication, and data routing between base station 101, base station 103, and external networks (e.g., data network 109). Core network 107 may be representative of a third generation (3G) network, fourth generation (4G) network, fifth generation (5G) network, sixth generation (6G) network, or other wireless core network architectures. Core network 107 may include control plane functions such as mobility management, session management, authentication, and policy enforcement, as well as user plane functions for data transport and routing. In the context of the present technology, while core network 107 facilitates overall connectivity, the dynamic power adjustment process is primarily executed at the base station level through direct X2 interface communication, minimizing the processing burden on core network 107.

Data network 109 represents an external network infrastructure that facilitates data exchange between core network 107 and various external services, applications, or computing resources. Data network 109 may include the internet, a private enterprise network, a cloud computing platform, an edge computing system, or the like. Data network 109 is responsible for receiving, processing, and delivering data packets transmitted by UE 105 via base station 101 or base station 103 and core network 107, as well as forwarding downlink data for UE 105. Data network 109 supports various communication protocols, security mechanisms, and traffic management functions to provide reliable and efficient data delivery.

In operation, UE 105 transmits signal strength reports to at least base station 101 and base station 103. These reports include RSRP measurements that indicate the signal strength UE 105 is receiving from each base station. Based on these reports, either base station 101 or base station 103 determines that it has the stronger signal and assumes the role of master cell. The master cell then initiates the power adjustment process, increasing its own transmission power while instructing at least one other base station to reduce its transmission power. This coordinated adjustment creates a dominant coverage area at the cell edge, reducing interference and improving signal quality for UE 105. The power adjustments may be dynamically managed based on continuous monitoring of signal conditions, ensuring optimal network performance as UE 105 moves or as network conditions change.

In exemplary embodiments described herein, the power adjustment and monitoring process operates continuously, with base stations dynamically adjusting their transmission power levels based on real-time signal reports without reverting to predetermined “normal” values. The system continuously evaluates UE signal strength reports and refines power settings as network conditions evolve, creating a perpetually optimized radio environment. However, alternative embodiments are also contemplated within the scope of this disclosure. In some implementations, the power adjustments may include a timeout mechanism where the boost/de-boost remains active for a predetermined period before reverting to baseline levels, unless renewed based on fresh UE reports. Other variations may incorporate triggering events that end or modify the boost/de-boost configuration, such as detected changes in network congestion, UEs moving away from the cell edge area, significant changes in network load, or scheduled maintenance windows. Additionally, some embodiments may implement hysteresis thresholds to prevent oscillations in power adjustments or gradual stepping of power levels to minimize abrupt changes in the network environment. These alternative approaches to managing the duration and termination of power adjustments are all contemplated within the scope of the present disclosure.

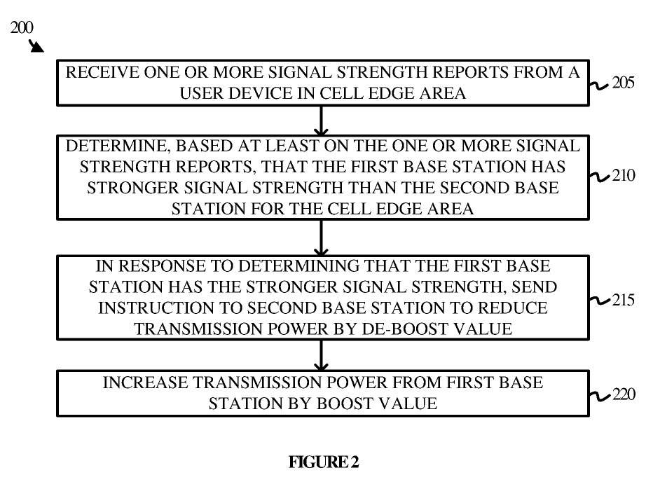

FIG. 2 illustrates process 200. Process 200 is an exemplary operation of dynamic power adjustment for cell edge interference mitigation in wireless communications environment 100. The operations may vary in other examples. The operations of process 200 are performed by a base station, such as base station 101 in the example of FIG. 1.

The operations of process 200 include receiving one or more signal strength reports from a user device in a cell edge area (step 205). In the example of FIG. 1, base station 101 receives signal strength reports from UE 105, which is located in a cell edge area. UE 105 periodically transmits these reports to provide real-time feedback on current signal conditions. The signal strength reports include Reference Signal Received Power (RSRP) measurements in dBm that indicate the signal strength UE 105 is receiving from both base station 101 and base station 103. These reports may be sent at predefined intervals, such as every few milliseconds, or may be triggered by specific events, such as significant changes in signal quality or UE mobility. The signal strength reports provide base station 101 with critical information about the radio environment at the cell edge, enabling intelligent power management decisions.

The operations of process 200 further include determining, based at least on the one or more signal strength reports, that the first base station has a stronger signal strength than the second base station for the cell edge area (step 210). In the example of FIG. 1, base station 101 analyzes the signal strength reports received from UE 105 to determine whether its signal is stronger than the signal from base station 103. This determination may be performed by an AI algorithm deployed on base station 101, which compares the RSRP values reported for each base station. In some implementations, base station 101 may also consider signal strength reports from multiple UEs in the cell edge area to ensure that its determination is representative of the broader coverage conditions rather than being based on a single UE’s experience.

The operations of process 200 further include, in response to determining that the first base station has the stronger signal strength, sending an instruction to the second base station to reduce transmission power by a de-boost value (step 215). In the example of FIG. 1, after determining that it should be the master cell, base station 101 communicates with base station 103 via the X2 interface to instruct base station 103 to reduce its transmission power by a specific de-boost value. This de-boost value may be calculated by the AI algorithm based on the current signal strength measurements, the difference between the competing signals, network performance objectives, or the like. The X2 interface allows direct communication between base stations without requiring intervention from core network 107, enabling rapid coordination of power adjustments. The instruction includes the specific de-boost value, which may be expressed in dB, and may also include additional parameters such as the duration of the adjustment or the affected frequency bands. In some implementations, base station 101 may determine, based on multiple signal strength reports from multiple UEs located in the cell edge area, that it has the stronger signal strength for the UE 105 and a majority of the other user devices in the cell edge area before instructing base station 103 to reduce its transmission power.

The operations of process 200 further include increasing transmission power from the first base station by a boost value in response to determining that the first base station has the stronger signal strength (step 220). In the example of FIG. 1, base station 101 increases its own transmission power by the boost value, which is typically equal to the de-boost value applied to base station 103. For example, if base station 103 is instructed to reduce its power by 3 dB, base station 101 may increase its power by 3 dB. This coordinated adjustment creates a greater separation between the signal strengths at the cell edge, effectively establishing base station 101 as the dominant server for UE 105. The power adjustment primarily affects the synchronization signal block (SSB) power, which is crucial for cell selection and initial access procedures. By boosting its SSB power while simultaneously reducing the SSB power of neighboring base stations, base station 101 creates a more favorable radio environment for UE 105 with reduced interference. This improvement in signal quality enables higher modulation schemes, leading to increased throughput and improved performance for UEs in the cell edge area.

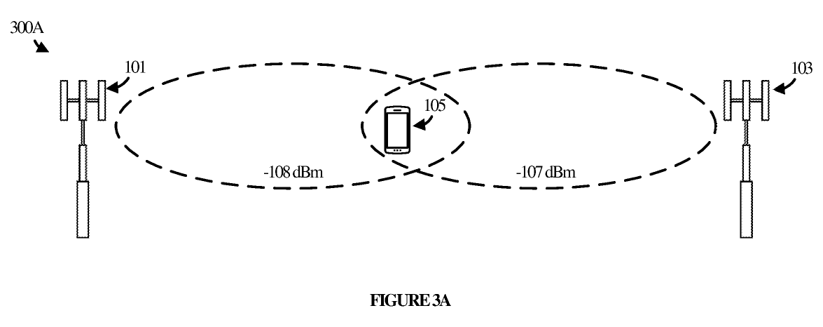

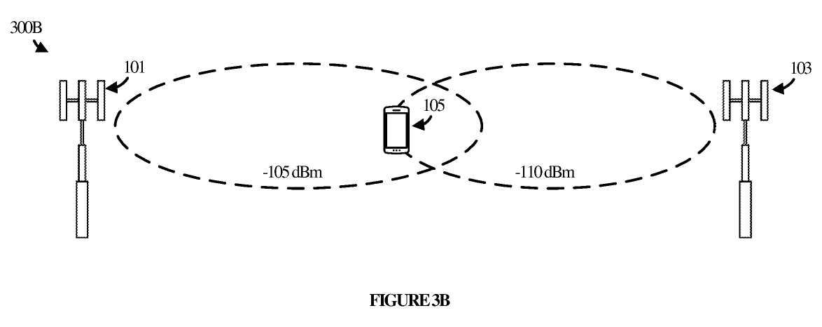

FIGS. 3A and 3B illustrate before and after states of a cell edge area undergoing dynamic power adjustment to mitigate interference in a wireless communications environment. FIG. 3A illustrates cell edge scenario 300A, which is representative of a wireless communications scenario before a power adjustment. FIG. 3A includes base station 101, base station 103, and UE 105 positioned in a cell edge area where coverage from multiple base stations overlaps. The components shown in FIG. 3A are merely for purposes of example, and cell edge scenario 300A may include additional, fewer, or different elements than those illustrated in the example of FIG. 3A.

In cell edge scenario 300A, UE 105 is located in an area where it receives signals from both base station 101 and base station 103 with similar signal strengths. As shown in the figure, UE 105 is receiving a signal from base station 101 with an RSRP value of -108 dBm and a signal from base station 103 with an RSRP value of -107 dBm. The similar signal strengths create an interference condition where neither base station has a clearly dominant signal. This interference scenario is particularly problematic because UE 105 cannot establish a strong connection to either base station. Even though both signals are detectable, the interference between them degrades the overall signal quality, resulting in a poor signal-to-interference-plus-noise ratio (SINR). The degraded SINR forces the network to use lower-order modulation schemes for data transmission, which significantly reduces throughput and can lead to connectivity issues such as slow data speeds or call drops.

FIG. 3B illustrates cell edge scenario 300B, which is representative of the same wireless communications scenario after power adjustment. FIG. 3B depicts the same components as FIG. 3A—base station 101, base station 103, and UE 105—but shows the effect of the dynamic power adjustment process. The components shown in FIG. 3B are merely for purposes of example, and cell edge scenario 300B may include additional, fewer, or different elements than those illustrated in the example of FIG. 3B.

In cell edge scenario 300B, the dynamic power adjustment process has been executed to create a dominant server at the cell edge. Based on the signal strength reports received from UE 105, base station 101 has determined that it should serve as the master cell despite initially having a slightly weaker signal than base station 103. Following this determination, base station 101 has increased its transmission power by a boost value of 3 dB, while instructing base station 103 via the X2 interface to reduce its transmission power by a de-boost value of 3 dB. As a result of these coordinated adjustments, UE 105 now receives a signal from base station 101 with an RSRP value of -105 dBm (improved from -108 dBm) and a signal from base station 103 with an RSRP value of -110 dBm (reduced from -107 dBm). This creates a significant 5 dB separation between the two signals, establishing base station 101 as the clear dominant server for UE 105. The improved signal differential reduces interference and enhances the SINR, enabling higher-order modulation schemes and resulting in improved throughput and connection reliability for UE 105.

The comparison between FIGS. 3A and 3B demonstrates the effectiveness of the dynamic power adjustment process in transforming a problematic interference scenario into an optimized radio environment. By creating a clear dominant server through coordinated power adjustments, the system significantly improves cell edge performance without requiring additional spectrum resources or hardware deployments. This improvement in radio conditions directly translates to enhanced user experience through faster data rates, more reliable connectivity, and reduced likelihood of call drops or service interruptions.

While the examples in FIGS. 3A and 3B illustrate a scenario with two base stations, the dynamic power management system is equally applicable to environments with three or more overlapping base stations. In such multi-cell interference scenarios, the base station with the strongest signal becomes the master cell and issues de-boost commands to all other base stations contributing to interference at the cell edge. In some examples, each secondary base station receives an individualized de-boost value calculated by the AI algorithm based on its specific contribution to the interference and its relative signal strength. For example, a third base station with a signal strength of -109 dBm might receive a de-boost command of 2 dB, while the second base station with a signal strength of -107 dBm receives a de-boost command of 3 dB. This granular power control ensures optimal interference mitigation even in complex network environments with multiple overlapping coverage areas. The X2 interface enables the master cell to communicate simultaneously or near-simultaneously with multiple neighboring base stations, coordinating the power adjustments across the entire affected area.

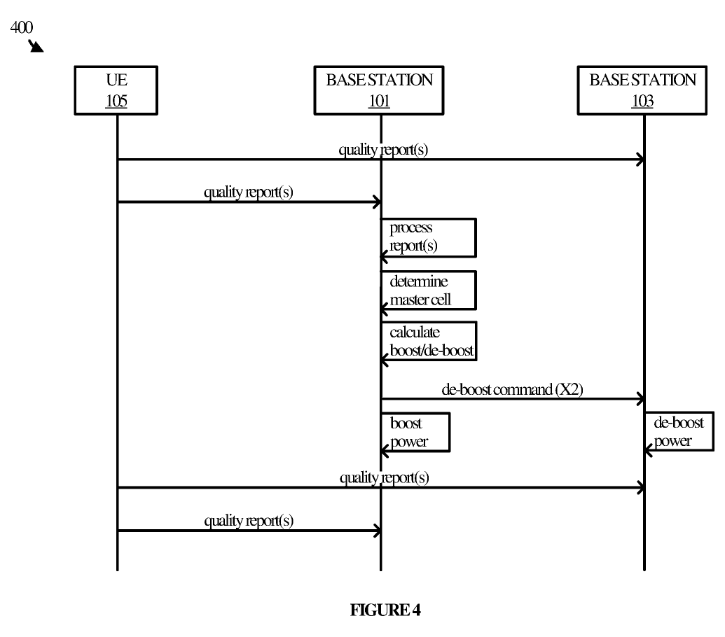

FIG. 4 illustrates sequence diagram 400. Sequence diagram 400 depicts an example sequence for dynamic power management in a cell edge area of a wireless communications environment. Sequence diagram 400 provides a representative flow of signaling interactions between base station 101, base station 103, and UE 105 as part of the dynamic power boost and de-boost process. The specific interactions, operational steps, and message exchanges shown in FIG. 4 are exemplary and may vary in different implementations.

The sequence begins with UE 105 transmitting quality reports to both base station 101 and base station 103. These quality reports include RSRP measurements that indicate the signal strength UE 105 is receiving from each base station. UE 105 may transmit these reports periodically as part of standard network measurement procedures, or the reports may be triggered by specific events such as deteriorating signal quality or UE movement into a cell edge area. Both base station 101 and base station 103 receive these quality reports, which provide information about the radio environment at the cell edge area where UE 105 is located.

Upon receiving the quality reports from UE 105, base station 101 processes the reports to analyze the current signal conditions. This processing involves comparing the RSRP values reported for each base station and evaluating whether there is sufficient signal overlap to warrant interference mitigation measures. Based on this analysis, base station 101 determines that it has the stronger signal for UE 105 and should therefore serve as the master cell for the dynamic power adjustment process. This determination may be made by the AI algorithm deployed on base station 101, in some examples. In some implementations, the AI algorithm evaluates not only the absolute signal strengths but also factors such as signal quality, network load, and historical performance data.

After establishing itself as the master cell, the AI algorithm running on base station 101 calculates the appropriate boost and de-boost values to optimize signal quality at the cell edge. The boost value represents the amount by which base station 101 will increase its transmission power, while the de-boost value indicates how much base station 103 should reduce its transmission power. These values are typically equal (e.g., 3 dB each) to create a significant signal differential without changing the overall power budget of the network. The calculation of these values may consider factors such as the current signal strength difference, the number of affected UEs, network performance objectives, and the like.

With the boost and de-boost values determined, base station 101 sends a de-boost command to base station 103 via the X2 interface. This command instructs base station 103 to reduce its transmission power by the specified de-boost value. The command may optionally include additional parameters such as the affected frequency bands, duration of the adjustment, or specific sectors to be adjusted.

Upon receiving the de-boost command, base station 103 reduces its transmission power according to the specified value. Base station 101 also increases its own transmission power by the calculated boost value. In some examples, base station 101 and base station 103 adjust their transmission power simultaneously or near-simultaneously. These coordinated power adjustments create a dominant sector coverage at the cell edge, with base station 101 providing a significantly stronger signal than base station 103. This reduction in competing signal strengths minimizes interference and improves the overall SINR for UE 105.

Following the power adjustments, UE 105 continues to transmit quality reports to both base stations. These reports may now reflect improved signal conditions, with measurements showing stronger signal strength from base station 101 and reduced signal strength from base station 103. By continuing to monitor these reports, both base stations can evaluate the effectiveness of the power adjustments and make further refinements if necessary. If network conditions change significantly—such as UE 105 moving away from the cell edge or new UEs entering the area—the base stations may initiate a new round of power adjustment calculations to maintain optimal signal quality.

In some implementations, the process depicted in sequence diagram 400 operates continuously, with base stations dynamically adjusting their transmission powers based on real-time quality reports. This continual optimization ensures that devices at cell edges continue to experience the best signal quality available despite changing network conditions. Alternative implementations may include timeout mechanisms where power adjustments revert to baseline levels after a predetermined period unless renewed based on fresh quality reports, or hysteresis thresholds to prevent oscillations in power adjustments when signal conditions fluctuate around threshold values.

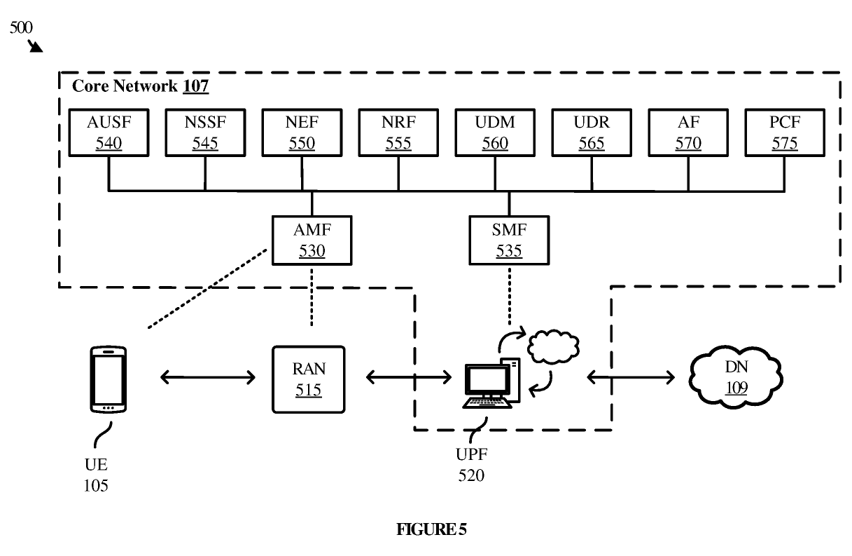

FIG. 5 illustrates 5G communication network 500. 5G communication network 500 is representative of a 5G communication network as disclosed herein in which dynamic power management processes for cell edge interference mitigation may be implemented. 5G communication network 500 may be representative of wireless communications environment 100 in FIG. 1 in some examples. 5G communication network 500 includes core network 107, UE 105, radio access network (RAN) 515, user plane function (UPF) 520, and data network 109. Core network 107 includes Access and Mobility Management Function (AMF) 530, Session Management Function (SMF) 535, Authentication Server Function (AUSF) 540, Network Slice Selection Function (NSSF) 545, Network Exposure Function (NEF) 550, Network Repository Function (NRF) 555, Unified Data Management (UDM) 560, Unified Data Repository (UDR) 565, Application Function (AF) 570, and Policy Control Function (PCF) 575. In other examples, 5G communication network 500 may include different or additional elements than those illustrated in FIG. 5 including but not limited to a session communication proxy (SCP), a migration function, a provisioning orchestrator, a customer relationship management (CRM) client, and the like.

RAN 515 represents a radio access network that facilitates communication between UE 105 and core network 107. RAN 515 includes base station 101 and base station 103 from FIG. 1, as well as other base stations not shown in FIG. 1. RAN 515 may be implemented with various types of base stations, including macrocells, microcells, and femtocells, supporting 5G, 4G LTE, and other cellular technologies. The base stations within RAN 515 communicate with each other via X2 interfaces, enabling the coordinated power boost and de-boost operations that mitigate interference at cell edges. In the context of the present disclosure, RAN 515 serves as the network segment where the dynamic power management decisions are primarily executed, with base stations analyzing UE signal reports and adjusting transmission powers to create dominant sector coverage in areas with overlapping signals.

While FIG. 5 depicts core network 107 as a 5G core network with 5G-specific network functions, in other implementations, core network 107 may be a 4G Evolved Packet Core (EPC), a 6G core network, or other types of core networks, depending on the network deployment scenario. The dynamic power management techniques disclosed herein for cell edge interference mitigation may be adapted to work across different generations of network technologies, with appropriate modifications to the signaling protocols and interfaces between network elements.

AMF 530 is responsible for access and mobility management including the initial registration of devices, authentication, tracking area management, and ensuring that users remain connected as they move through the network. AMF 530 serves as the point of contact for a user device (e.g., UE 105) when it tries to connect to the 5G network (e.g., 5G communication network 500). AMF 530 manages the establishment, maintenance, and termination of the connection between UE 105 and core network 107. SMF 535 is responsible for session management including establishing, modifying, and releasing sessions (which comprise of one or more data flows). SMF 535 also selects and manages the user plane functions, handles aspects of internet protocol (IP) address allocation, and maintains the rules for how data should be routed and reported. SMF 535 ensures that data can be successfully transmitted between UE 105 and the internet or other network services.

AUSF 540 is also responsible for aspects of user authentication. AUSF, in part, generates and validates authentication vectors to ensure that the requesting device is a legitimate subscriber of 5G communication network 500. Upon successful authentication, AUSF 540 contributes to establishing a secure communication channel between UE 105 and core network 107 by facilitating the generation and distribution of security keys. AUSF 540 may also support network slicing by authenticating access to different network slices based on user subscription. AUSF 540 also supports roaming by interacting with corresponding authentication functions in other networks.

NSSF 545 is responsible for selecting the appropriate network slice for UE 105 based on the user’s subscription data and requested service. This may involve determining which slice or slices are best suited to meet the specific service requirements and the subscription profile associated with UE 105. NSSF 545 is also responsible for enforcing policies related to network slice access, managing information about the network slices, and interacting with other core network functions to ensure that UE 105 is connected to the correct slice and that slice-specific rules are applied.

NEF 550 plays a role in securely exposing the capabilities of core network 107 to external applications and services. NEF 550 may perform functions such as providing standardized application programming interfaces (APIs) for third-party services to access specific network capabilities or information and ensuring that the exposure of network capabilities and user data is managed securely and user privacy is maintained. NRF 555 acts as a central registry and discovery service for the network functions within core network 107. NRF 555 allows other network functions to register their services and discover the services provided by other network functions, maintains up-to-date information on the services offered by different network functions, supports load balancing and fault tolerance mechanisms within the network, and supports the scalability of the network.

UDM 560 is a central entity for managing subscriber data and authentication information. UDM 560 stores and manages subscription-specific information and is responsible for handling the authentication and authorization of users trying to access the network. Although not directly managing sessions, UDM 560 provides necessary information to other network functions, such as AMF 530 and SMF 535, to assist in session establishment and management based on the subscriber's data. UDM 560 also supports seamless service continuity and roaming by managing user identities and security information across different types of networks.

UDR 565 acts as a database (or multiple databases) for storing and managing structured subscriber data and service information. UDR 565 manages access to subscription data for other network functions such as AMF 530, SMF 535, and UDM 560. AF 570 is representative of external applications and services that may need to interact with core network 107 for various purposes. PCF 575 is responsible for policy management, which involves creating and enforcing policy rules for network behavior and user data transmission.

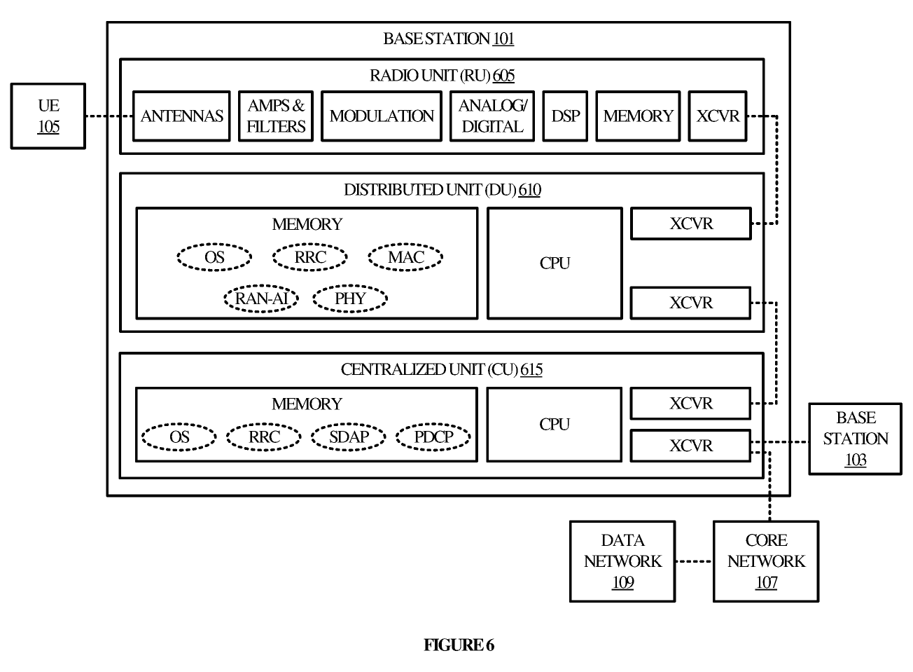

FIG. 6 illustrates an example of base station 101 from the preceding Figures in which base station 101 is a gNB configured for use in a 5G network (e.g., 5G communication network 500). In the example of FIG. 6, base station 101 is wirelessly coupled to UE 105, core network 107, and data network 109 via core network 107. Base station 101 is also connected to base station 103 via the X2 interface, which enables direct communication between neighboring base stations for coordinated power management as described herein. Base station 101 may differ from what is shown in the example of FIG. 6.

In the example of FIG. 6, base station 101 includes radio unit (RU) 605, distributed unit (DU) 610, and centralized unit (CU) 615. RU 605 may include but is not limited to antennas, amplifiers, filters, modulation, analog-to-digital interfaces, DSP, memory, and XVCRs that are coupled over bus circuitry. UE 105 is wirelessly coupled to antennas in RU 605 over 5GNR (5G New Radio) links. Transceivers in RU 605 are coupled to transceivers in DU 610 over fronthaul links like enhanced common public radio interface (eCPRI). The DSPs in RU 605 execute their operating systems and radio applications to exchange 5GNR signals with UE 105 and to exchange 5GNR data with DU 610.

For the uplink, the antennas in RU 605 receive wireless signals from UE 105 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 610 over the transceivers.

For the downlink, the DSPs receive downlink 5GNR symbols from DU 610. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 105 that transport the downlink 5GNR signaling and data. During the dynamic power management process, RU 605 is responsible for implementing the power boost or de-boost adjustments calculated by the AI algorithm, modifying the transmission power of the synchronization signal blocks (SSBs) as instructed.

DU 610 may include but is not limited to memory, CPU, and XCVRs that are coupled over bus circuitry. The memory in DU 610 stores operating systems (OS) and 5GNR network applications like RRC, MAC, and PHY. DU 610 also includes RAN-AI, which is representative of an artificial intelligence module that implements the AI algorithm responsible for the dynamic power management functionality described herein. The RAN-AI module may analyze signal strength reports from UEs, determine whether base station 101 should serve as the master cell, calculate appropriate boost and de-boost values, and/or initiate the power adjustment process. The RAN-AI module may use various machine learning techniques, such as supervised learning, reinforcement learning, or neural networks, to optimize power management decisions based on network conditions and historical performance data.

CU 615 may include but is not limited to memory, CPU, and XCVRs that are coupled over bus circuitry. The memory in CU 615 stores an OS and 5GNR network applications like PDCP, SDAP, and RRC. Transceivers in DU 610 may be coupled to transceivers in RU 605 over front-haul links. Transceivers in DU 610 may be coupled to transceivers in CU 615 over mid-haul links. Additionally, transceivers in DU 610 facilitate communication with base station 103 via the X2 interface, enabling the coordination of power adjustments between neighboring cells.

RRC functions may include but are not limited to connection establishment and release, radio bearer configuration, mobility control, paging coordination, and security configuration. The RRC layer may send control messages to UEs to report signal strength measurements, which are crucial for the dynamic power management process. MAC functions may include but are not limited to buffer status reporting, power control, channel quality measurement, HARQ management, user identification, random access coordination, user scheduling, and QoS enforcement. The MAC layer is involved in processing and forwarding UE signal strength reports to the RAN-AI module and implementing power adjustment decisions.

PHY functions may include but are not limited to packet formation/deformation, guard-insertion/guard-deletion, parsing/de-parsing, control insertion/removal, interleaving/de-interleaving, FEC encoding/decoding, channel coding/decoding, channel estimation/equalization, rate matching/de-matching, scrambling/descrambling, modulation mapping/de-mapping, layer mapping/de-mapping, precoding, RE mapping/de-mapping, FFTs/IFFTs, and DFTs/IDFTs. The PHY layer executes the actual power adjustments on the SSB signals as determined by the RAN-AI module.

PDCP functions may include but are not limited to security ciphering, header compression and decompression, sequence numbering and re-sequencing, de-duplication. SDAP functions include QoS marking and flow control. RRC functions may include but are not limited to authentication, security, handover control, status reporting, QoS, network broadcasts and pages, network selection, SINR calculation, transmitter power tracking, feature vector preparation, and cell bandwidth control.

While FIG. 6 specifically depicts base station 101, base station 103 and other base stations in the network may have similar architectures, including their own RAN-AI modules capable of analyzing signal reports and executing power adjustments. This enables any base station in the network to serve as either a master cell (implementing a power boost) or a secondary cell (implementing a power de-boost) depending on the specific conditions at each cell edge area.

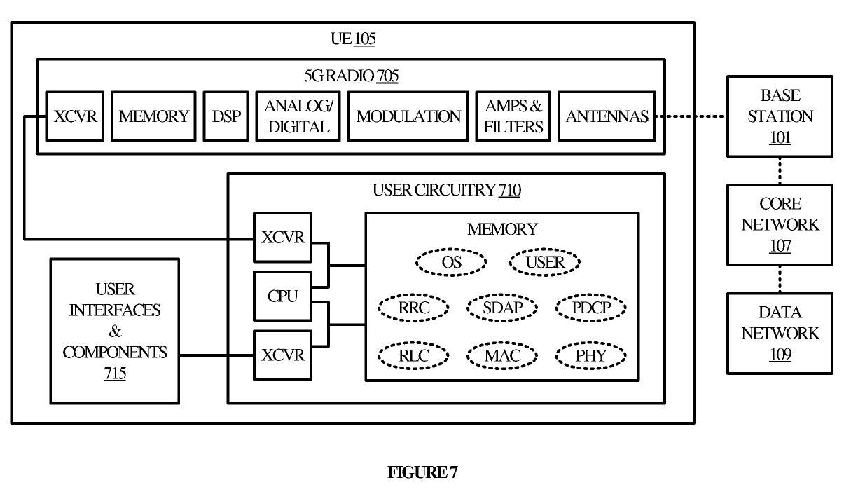

FIG. 7 illustrates an example of UE 105 from the preceding Figures in which UE 105 is configured for use in a 5G network (e.g., 5G communication network 500). In the example of FIG. 7, UE 105 is wirelessly coupled to base station 101, core network 107 via base station 101, and data network 109 via core network 107. UE 105 may also be wirelessly connected to base station 103 and/or other base stations in the network, particularly when located in cell edge areas where coverage from multiple base stations overlaps. UE 105 may differ from what is shown in the example of FIG. 7. UE 105, in the example of FIG. 7, includes 5G radio 705, user circuitry 710, and user interfaces and components 715. 5G radio 705 includes 5GNR antennas, amplifiers, filters, modulation, analog-to-digital interfaces, digital signaling processors (DSPs), memory, and radio transceiver circuitry (XCVR) that are coupled over bus circuitry. User circuitry 710 includes memory, CPU, and XCVRs that are coupled over bus circuitry.

The memory in user circuitry 710 stores an operating system (OS), user applications (USER), and 5GNR network applications for the physical layer (PHY), MAC layer, radio link control (RLC), packet data convergence protocol (PDCP), service data adaptation protocol (SDAP), and RRC. The antennas in 5G radio 705 are wirelessly coupled to base station 101 over a 5GNR link. Transceivers in 5G radio 705 are coupled to a transceiver in user circuitry 710. Another transceiver in user circuitry 710 is coupled to user interfaces and components 715, which may include displays, controllers, and/or memory.

In 5G radio 705, the antennas receive wireless signals from base station 101 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 710 over the transceivers.

In user circuitry 710, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data. In the context of the dynamic power management system described in this disclosure, UE 105 also generates and transmits signal strength reports that include RSRP measurements for base station 101, base station 103, and any other base stations within range. These reports allow the network to identify interference conditions at cell edges and initiate appropriate power boost and de-boost adjustments.

In 5G radio 705, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to base station 101 that transport the uplink 5GNR signaling and data, including the critical signal strength reports that enable dynamic power management at cell edges.

RRC functions may include but are not limited to authentication, security, handover control, status reporting, QoS, network broadcasts and pages, and network selection. SDAP functions may include but are not limited to QoS marking and flow control. PDCP functions may include but are not limited to security ciphering, header compression and decompression, sequence numbering and re-sequencing, de-duplication. RLC functions may include but are not limited to automatic repeat request (ARQ), sequence numbering and resequencing, segmentation and resegmentation.

MAC functions may include but are not limited to buffer status, power control, channel quality, HARQ, user identification, random access, user scheduling, and QoS. The MAC layer is particularly important for measuring and reporting channel quality indicators and reference signal received power values from multiple base stations, which are essential inputs for the dynamic power management process. PHY functions may include but are not limited to packet formation/deformation, windowing/de-windowing, guard-insertion/guard-deletion, parsing/de-parsing, control insertion/removal, interleaving/de-interleaving, forward error correction (FEC) encoding/decoding, channel coding/decoding, channel estimation/equalization, and rate matching/de-matching, scrambling/descrambling, modulation mapping/de-mapping, layer mapping/de-mapping, precoding, resource element (RE) mapping/de-mapping, fast Fourier transforms (FFTs)/inverse FFTs (IFFTs), and discrete Fourier transforms (DFTs)/inverse DFTs (IDFTs).

In the context of the dynamic power management system described in this disclosure, UE 105 exemplifies how user devices at cell edges may interact with multiple base stations simultaneously. When located in a cell edge area, UE 105 can detect signals from two or more base stations (e.g., base station 101 and base station 103), and report the respective signal strengths to the network. Based on these reports, the network can identify when UE 105 is experiencing interference due to competing signals of similar strength. The RAN-AI system then determines which base station should serve as the master cell and implements coordinated power adjustments to create a dominant sector coverage. This process significantly improves the signal quality that UE 105 experiences, enabling higher modulation schemes and increased throughput without requiring UE 105 to be modified or to take any special actions beyond its standard reporting functions. While FIG. 7 specifically depicts UE 105, the same architecture and functionality would apply to any user devices that may be located in cell edge areas throughout the network.

Although the descriptions provided herein may be in the context of certain radio access technologies, networks, and network topologies, such as 4G LTE or 5GNR mobile communications, the proposed concepts, schemes, and any variations thereof may be implemented in, for, and by other types of radio access technologies, networks, and network topologies. Such radio access technologies, networks, and network topologies may include, for example and without limitation, Internet-of-Things (IoT), Narrow Band Internet of Things (NB-IoT), vehicle-to-everything (V2X), fixed wireless internet, non-terrestrial networks (NTN), and space-based technologies, such as communications involving low Earth orbit (LEO), medium Earth orbit (MEO), or geostationary orbit (GEO) satellites. Thus, the scope of the disclosure is not limited to the examples described herein.

As will be appreciated by one skilled in the art, aspects of the present technology may be embodied as a system, method, computer program product, or otherwise. Accordingly, aspects of the present technology may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present technology may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the technology disclosed herein is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms ‘connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples of the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method comprising:
receiving, by a first base station, one or more signal strength reports from a user device located in a cell edge area, wherein the one or more signal strength reports include at least a signal measurement from the first base station and a signal measurement from a second base station;
determining, based at least on the one or more signal strength reports, that the first base station has a stronger signal strength than the second base station for the cell edge area; and
in response to determining that the first base station has the stronger signal strength, sending an instruction to the second base station to reduce a transmission power from the second base station by a de-boost value, and increasing a transmission power from the first base station by a boost value.

2. The method of claim 1, wherein determining that the first base station has the stronger signal strength is performed by an artificial intelligence (AI) algorithm deployed on the first base station.

3. The method of claim 2, wherein the AI algorithm analyzes the one or more signal strength reports to determine the de-boost value and the boost value.

4. The method of claim 1, further comprising:
in addition to receiving the one or more signal strength reports from the user device, receiving other signal strength reports from other user devices located in the cell edge area; and
determining that the first base station has the stronger signal strength for a majority of the other user devices and the user device before sending the instruction to reduce the transmission power from the second base station.

5. The method of claim 1, wherein:
the one or more signal strength reports further include at least a signal measurement from a third base station; and
the method further comprises sending a second instruction to the third base station to reduce a transmission power from the third base station by a second de-boost value.

6. The method of claim 1, wherein sending the instruction to the second base station comprises communicating with the second base station via an X2 interface.

7. The method of claim 1, wherein the transmission power from the first base station and the transmission power from the second base station comprises synchronization signal block (SSB) power.

8. The method of claim 1, wherein the de-boost value and the boost value are equal.

9. The method of claim 1, wherein determining that the first base station has the stronger signal strength comprises comparing a first reference signal received power (RSRP) value associated with the first base station to a second RSRP value associated with the second base station.

10. A system comprising:
one or more computer-readable storage media;
a processing system operatively coupled with the one or more computer-readable storage media; and
program instructions stored on the one or more computer-readable storage media, wherein the program instructions, when read and executed by the processing system, direct the processing system to at least:
receive, by a first base station, one or more signal strength reports from a user device located in a cell edge area, wherein the one or more signal strength reports include at least a signal measurement from the first base station and a signal measurement from a second base station;
determine, based at least on the one or more signal strength reports, that the first base station has a stronger signal strength than the second base station for the cell edge area; and
in response to determining that the first base station has the stronger signal strength, send an instruction to the second base station to reduce a transmission power from the second base station by a de-boost value, and increase a transmission power from the first base station by a boost value.

11. The system of claim 10, wherein an artificial intelligence (AI) algorithm deployed on the first base station determines that the first base station has the stronger signal strength.

12. The system of claim 11, wherein the AI algorithm analyzes the one or more signal strength reports to determine the de-boost value and the boost value.

13. The system of claim 10, wherein the program instructions further direct the processing system to:
in addition to receiving the one or more signal strength reports from the user device, receive other signal strength reports from other user devices located in the cell edge area; and
determine that the first base station has the stronger signal strength for a majority of the other user devices and the user device before sending the instruction to reduce the transmission power from the second base station.

14. The system of claim 10, wherein:
the one or more signal strength reports further include at least a signal measurement from a third base station; and
the program instructions further direct the processing system to send a second instruction to the third base station to reduce a transmission power from the third base station by a second de-boost value.

15. The system of claim 10, wherein to send the instruction to the second base station, the program instructions direct the processing system to communicate with the second base station via an X2 interface.

16. The system of claim 10, wherein the transmission power from the first base station and the transmission power from the second base station comprises synchronization signal block (SSB) power.

17. The system of claim 10, wherein the de-boost value and the boost value are equal.

18. The system of claim 10, wherein to determine that the first base station has the stronger signal strength, the program instructions direct the processing system to compare a first reference signal received power (RSRP) value associated with the first base station to a second RSRP value associated with the second base station.

19. One or more non-transitory computer-readable storage media having program instructions stored thereon, wherein the program instructions, when executed by a computing system, direct the computing system to perform operations, the operations comprising:
receiving, by a first base station, one or more signal strength reports from a user device located in a cell edge area, wherein the one or more signal strength reports include at least a signal measurement from the first base station and a signal measurement from a second base station;
determining, based at least on the one or more signal strength reports, that the first base station has a stronger signal strength than the second base station for the cell edge area; and
in response to determining that the first base station has the stronger signal strength, sending an instruction to the second base station to reduce a transmission power from the second base station by a de-boost value, and increasing a transmission power from the first base station by a boost value.

20. The one or more non-transitory computer-readable storage media of claim 19, wherein determining that the first base station has the stronger signal strength comprises executing an artificial intelligence (AI) algorithm deployed on the first base station.
